(19) United States
(12) Patent Application Publication
(10) Pub. No.: US 2002/0084652 A1
(43) Pub. Date: Jul. 4, 2002

(54) Quick connector

(76) Inventors: Bernd Halbrock, Konigsbach-Stein (DE); Harald Twardawski, Rastatt (DE); Thomas Luft, Karlsruhe (DE); Michael Markus Huck, Buhlertal (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 09/993,996

(22) Filed: Nov. 14, 2001

(30) Foreign Application Priority Data
Nov. 23, 2000 (DE) 100 58 087.4

(51) Int. Cl. F16L 37/00

(52) U.S. Cl. 285/305

(57) ABSTRACT

A connecting device is provided particularly as a quick-connect device for connecting fluid channels on motor vehicles. The connecting device features two axial connecting elements that are to be clamped and that are sealed by a sealing element to be deformed in the axial direction. The deformation of the sealing element is limited by mechanical stop means (support surfaces). A wedge-clamping device is used for clamping the connecting elements against each other.

The invention pertains to a connecting device, particularly a quick-connect device for attaching or connecting fluid lines.

Fluid lines must often be connected to each other or to containers. What is important, particularly for automobile construction, is reliable impermeability and also easy assembly. Both easy assembly and impermeability must be guaranteed for large-scale production, i.e., they must be essentially independent of possible production tolerances in the precision of the associated coupling elements and other causes of faults.

A pipe-connection coupling with plug-in securing means is known from DE 197 37 704 A1. The pipe-connection coupling is used to connect pipe ends with an annular bead and an O-ring positioned in front of the annular bead. The connecting element is a socket part with a central opening featuring two lateral through openings for a plug-in fork. For guiding the plug-in fork during an insertion process, the socket part has inclined planes that impart a clamping movement to the plug-in fork during insertion. The plug-in fork grips behind the annular bead on the pipe end, pressing this pipe end against an annular shoulder in the pipe-insertion direction such that the O-ring between the pipe and the shoulder is clamped. The inclined planes form a guide-bar bracket for the plug-in fork, imparting a clamping movement to the plug-in fork in the first part of the insertion path. There is no further movement in the pipe-insertion direction after the clamping movement.

This plug coupling requires a relatively precise adherence to predetermined dimensions of the insertion part of the pipe end and the plug-in fork because the fixed setting of the pipe end is only guaranteed for an inserted plug-in fork when all relevant tolerances taken together are smaller than the maximum tolerance determined by the O-ring and its respective elastic excursion.

A similar connecting device is known from U.S. Pat. No. 5,513,882. This features a receptacle part with a stepped hole, wherein the steps have an axial annular groove. A second connecting part with an annular flange is inserted into the receptacle part, wherein the annular flange then presses against the O-ring. For securing this connection, there is a U-shaped insertion bracket, whose free ends are beveled and are to be inserted through the side openings of the receptacle part. The disadvantages mentioned above also apply here.

Another coupling device is known from DE 31 43 015 C3. The coupling halves of this quick-connect coupling are formed by a socket part and a plug part. The socket part features a cylindrical surface at its inner circumference. The plug part has a cylindrical surface at its outer circumference. An O-ring is held between both cylinder surfaces as a sealing element. For mechanical securing and support, there is a plastic socket arranged in the socket part adjacent to the O-ring. The plastic socket features a funnel-shaped end. A conical head of the plug part engages this funnel-shaped end. For one embodiment, a wedge-clamping device can be provided for the purpose of pressing the conical head into the plastic socket. However, the sealing behavior at the O-ring is determined by the diameter of the inner-circumference surface of the socket part and the outer-circumference surface of the plug part. The plug part and the socket part can be clamped against each other with a wedge-clamping device. The resulting relative axial positions do not take into account the sealing behavior at the O-ring.

This coupling device requires exact adherence to the inner and outer diameter of the associated socket and plug parts.

With this background, the problem of the invention is the design of a tolerance-insensitive connecting device suitable for use in automobiles.

This problem is solved with a connecting device according to claim 1.

The connecting device according to the invention features two connecting elements that are joined in the axial direction and that feature corresponding sealing surfaces oriented in the axial direction for a sealing element. For connecting the connecting elements and for securing these connecting elements together, there is a wedge-clamping device with at least one clamping wedge and at least one counter-clamping element, which clamp the connecting elements against each other. The wedge-clamping device is formed so that the wedge surfaces of the clamping wedge and the counter-clamping element contact each other when the connection is realized. The wedge surfaces are preferably formed with straight wedges so that the wedge can be inserted into one of the connecting elements with a linear insertion movement. In the assembled state, the wedge is in its active range, i.e., further pushing of the wedge into the connecting element would cause even tighter clamping of the connecting elements against each other. Thus, tolerance compensation is achieved, i.e., smaller production tolerances are compensated for by deeper or shallower insertion of the clamping wedge.

By means of the wedge-clamping device, axial forces can be generated that are applied to the sealing element and that are essentially greater than those for plug-in connections in which the sealing element contacts surfaces oriented in the radial direction (cylinder surfaces). The forces generated by the wedge-clamping device can be completely applied to the sealing element, whereby very large pressing forces can be achieved. Such large forces cannot be otherwise generated by manual joining of connections.

Due to the large forces that it generates, the wedge-clamping device enables the use of sealing elements that require large sealing force. For example, sealing elements can be used that cut into sealing surfaces oriented in the axial direction (e.g., short pipe pieces with sharp front sides) or that are permanently deformed by a pressing process. With the use of elastic sealing elements, a higher deformation can be achieved than for connection devices with sealing surfaces that are cylindrical or oriented in the radial direction, for which there is still relative movement between the connecting elements perpendicular to the deformation direction when the sealing element is already deformed. An essential advantage of the connecting device according to the invention is that deformation of the sealing element only occurs due to the wedge-clamping device and in the joining direction when the connecting elements are already joined.

The clamping wedge is preferably so flat that it is self-locking. This means that an axial loading of the connecting elements generates no displacement of the clamping wedge. Advantageously, the wedge angle is 1-15°. The wedge can also be provided with a locking device that secures it in the inserted state. The locking device preferably features several locking positions, so that both deeply inserted wedges and also less deeply inserted wedges can each be a secured in place. The locking device can be configured both without discrete steps and also with predetermined locking positions. First, e.g., in the simplest cases, the clamping wedge is realized with a clamping means or adhesive before insertion into the corresponding connecting element, which secures the position of the clamping wedge in the inserted state. The activation of the adhesive can be done through heat, mechanical stress (pressure), or chemicals.

However, form-fit securing of the clamping wedge, e.g., by a multiple-step locking device, is preferred. This can be formed through toothing in the outer circumference surface of a connecting element. An elastic locking finger connected to the wedge slides along this surface.

The sealing element of the connecting device is preferably an O-ring. This is clamped in the axial direction by joining the connecting elements. At first, this guarantees that the O-ring in the mounted state, independent of other tolerances, actually contacts the corresponding sealing surfaces in the pressing setting. If necessary, however, there can also be other sealing elements or several O-rings.

Instead of an O-ring, there can also be a composite sealing element featuring, e.g., an elastic annular section and a section that can likewise be formed with an annular shape and that is used to limit the deformation of the first section of the sealing element in the axial direction. This second, less elastically stiff section can be an annular, closed element that features two opposite flat surfaces that face away from each other and that contact corresponding support surfaces of the connecting elements. For such a sealing element, high impermeabilities (lowest leakage rates) can be achieved for a simple structure.

For a preferred embodiment, the sealing element is arranged adjacent to a pipe or tubular support section that features a support surface. The mentioned section is coaxial to the O-ring and is used to support the connecting element pushed into the corresponding connecting element. The support surface features an annular, closed support surface that contacts a corresponding support surface of the other connecting element without a gap. The clamping force of the wedge is used only in the first part of the clamping movement of the deformation of the O-ring or the other sealing element. As soon as the support surfaces contact each other, the wedge clamps the support surfaces tightly together. This achieves a defined setting of the O-ring that is independent of the relevant tolerances on the one hand, and a clamped connection between the connecting elements that is fixed in the axial direction, on the other. The alignment of the connecting elements relative to each other is realized by the support surfaces which guarantee a non-inclined setting and thus an ordinary clamping of the O-ring.

In a preferred embodiment, the support surfaces feature a diameter that is greater than the O-ring diameter. This means that the support element of the support part is arranged in the radial direction outside of and coaxial with the O-ring. This has significant meaning for the impermeability of the connecting devices, which can thus produce nearly completely leakage-free connections. The support surfaces enclose with each other an imperceptible gap that is sealed by the O-ring inwards with respect to the volume to be sealed. At its side facing the volume to be sealed (fluid channel), the O-ring features a relatively large surface accessible to the fluid. To the atmosphere, i.e., towards the outside, however, the O-ring merely exhibits the surface sealing the gap, which is nearly zero when the gap is closed. Therefore, at the outer side there is no significant surface, from which the fluid could reach the surroundings, for fluid diffusing through the O-ring. The surface ratio of inner surface to outer surface is nearly infinitely large, which achieves an absolute minimization of leakage. The connecting device can be considered to be permanently impermeable. In addition, due to the tight clamping of the support surfaces, they are resistant to vibration relative to each other and can be assembled with the simplest means.

The support surfaces can be planar surfaces. If necessary, however, they can also feature a certain curvature. Planar surfaces are preferred due to their simple manufacture and their clear sealing behavior.

If necessary, one of the support surfaces can also have a profile, e.g., ribbing that cuts into or deforms the other support surface. This can result in further improvement of the connection.

The connecting device is advantageously configured to be symmetrical about a longitudinal center plane, wherein two clamping wedges are used that are inserted into corresponding clamp openings at diametrically opposite sides of the connecting device. Advantageously, both wedges have the same orientation, so that they are pushed into the opening in the same direction. The clamping wedges can be connected together by a cross piece, which produces a yoke-like double wedge. The advantage of this embodiment lies in the symmetrical introduction of clamping forces into the connecting element to be clamped by the wedge, which leads to secure setting of the connecting element. It has been shown that two parallel wedges that are inserted on both sides of the tubular connecting element are sufficient. The assembly is simple.

An advantageous embodiment has a support surface that is separated from the connecting elements. This embodiment has the advantage that for identical connecting elements, different sealing elements can be used corresponding to requirements. The required measure of compression, by means of which the sealing element is pressed together in the axial direction, can then be determined individually for the sealing element by the support element.

Additional details of advantageous embodiments of the invention follow from the drawing or the subsequent description and/or are the object of subordinate claims.

Embodiments of the invention can be seen in the drawing. Shown are:

FIG. 1, a connecting device in the assembled state and in a perspective projection,

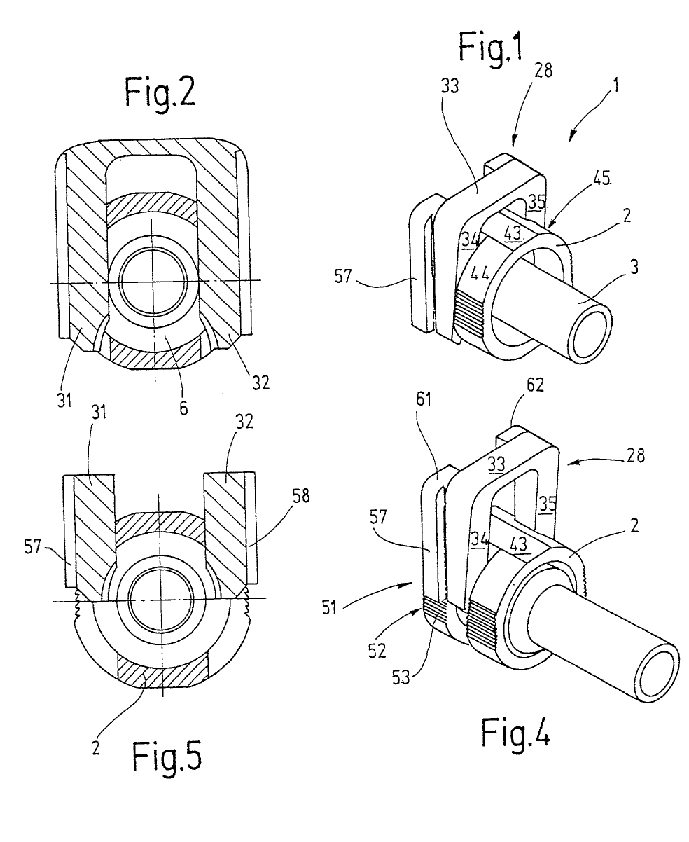

FIG. 2, the connecting device according to FIG. 1, in a perpendicular cross-sectional projection,

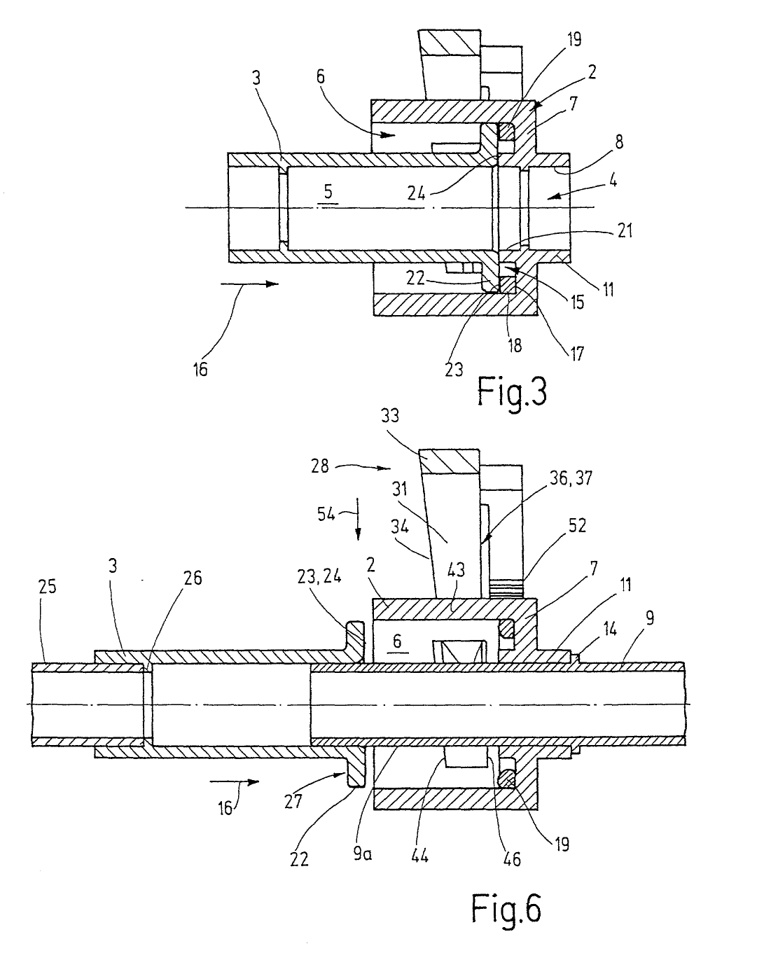

FIG. 3, the connecting device according to FIG. 1, in a longitudinal cross-sectional projection,

FIG. 4, the connecting device according to FIG. 1, in the disassembled state and in a perspective projection,

FIG. 5, the connecting device according to FIG. 4, in a perpendicular cross-sectional projection,

FIG. 6, the connecting device according to FIG. 4, in a longitudinal cross-sectional projection,

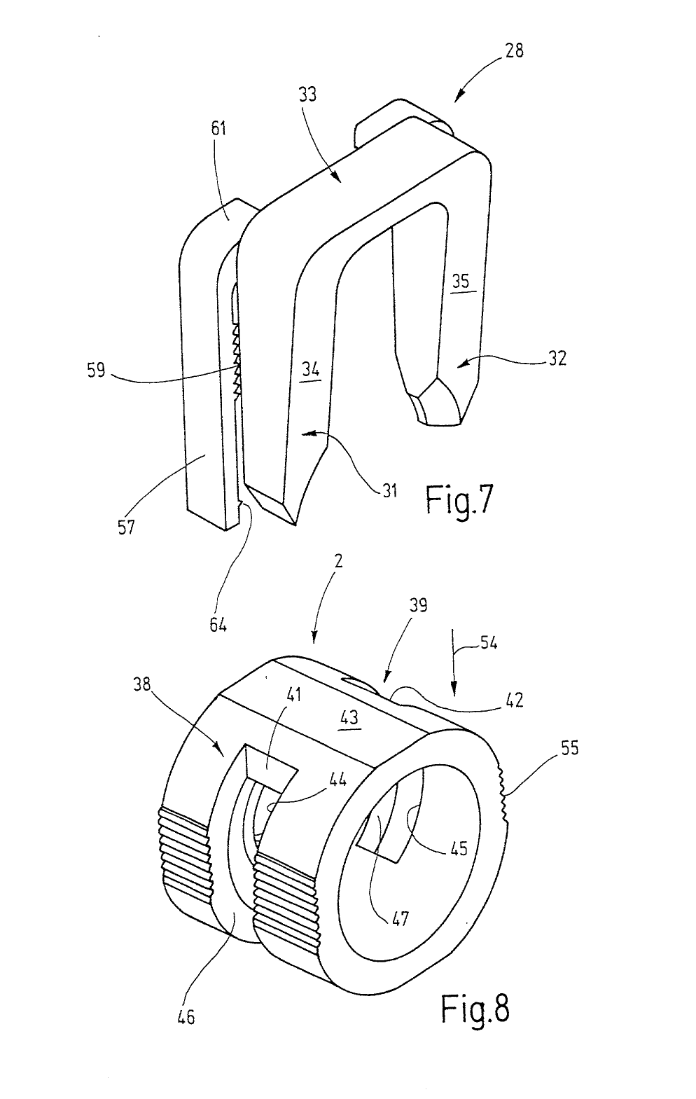

FIG. 7, a clamping wedge arrangement for the connecting device according to FIGS. 1-6, in a perspective projection and at another scale,

FIG. 8, a connecting element for the connecting device according to FIGS. 1-6, in a perspective projection and at another scale,

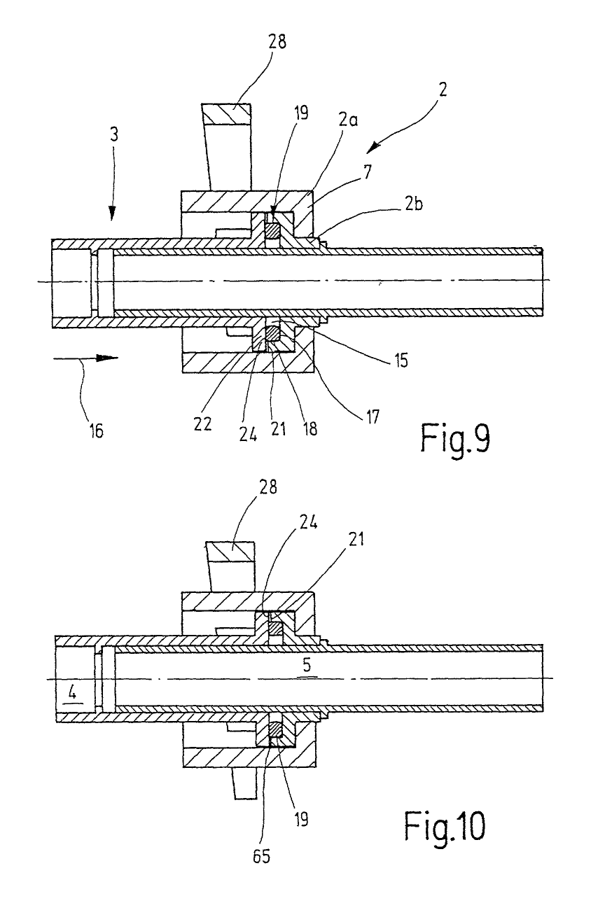

FIG. 9, an embodiment variant of the connecting device in a not yet completely assembled state, in a longitudinal cross-sectional projection,

FIG. 10, the connecting device according to FIG. 9, in a completely assembled state and in a longitudinal cross-sectional projection,

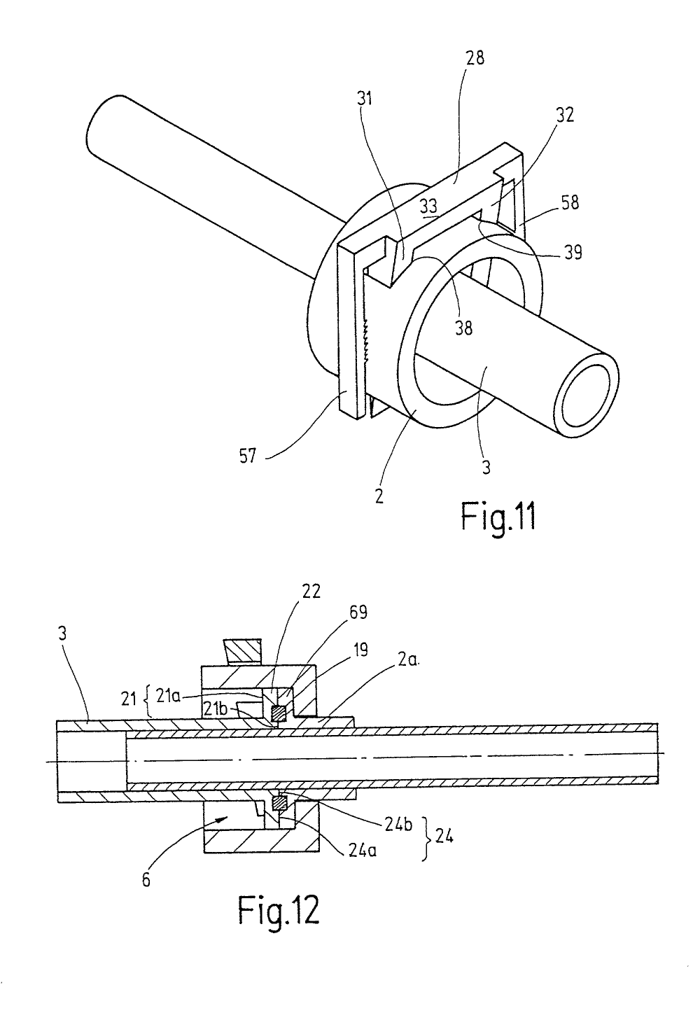

FIG. 11, an embodiment variant of the connecting device, in a perspective projection,

FIG. 12, the connecting device according to FIG. 11, in a longitudinal cross-sectional projection, and

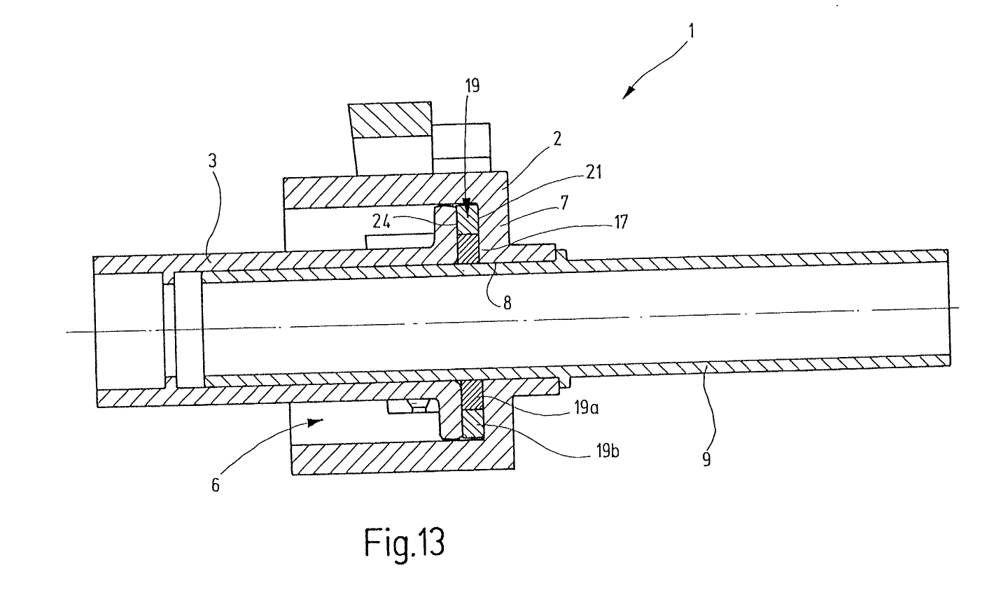

FIG. 13, an alternative embodiment of the invention, in a longitudinal cross-sectional projection.

FIG. 1 shows a connecting device 1 that is used as a quick-connect coupling for two fluid lines. The connecting device 1 includes a first connecting element 2 and a second connecting element 3 that surround a fluid channel 4, 5, respectively, and that are connected together to be fluid-tight, as can be seen from FIG. 3.

The first connecting element 2 features a somewhat cylindrical insertion space 6 that is open on one side. The connecting element 3 can be inserted into this insertion space. The insertion space 6 is formed in the connecting element 2 that is somewhat cylindrical on the outside, closed at one side by a front wall 7, and configured as a connecting piece. The front wall 7 features a connection opening 8 that directly surrounds the fluid channel 4 or that is used to connect a pipe end 9, as can be seen, e.g., from FIG. 6.

The connection opening 8 is defined by a tubular extension part 11 that is integrally connected with the front wall 7 and that projects both outwards (in FIG. 3, to the right) and also into the insertion space 6 (in FIG. 3, to the left) past the front wall 7. On its inner walls, the extension part 11 can be provided with an annular ribbing 12 that is used as a defined stop for a pipe end to be pushed in. Alternatively, as illustrated by FIG. 6, the ribbing 12 can be eliminated and a corresponding annular bead or ribbing 14 can be provided on the outer side of the pipe end 9 to be connected. The ribbing 14 can be positioned so that the pipe end 9 projects into or through the insertion space 6.

The pipe end 9 is connected to the connecting element 2, preferably in a non-detachable manner, e.g., by an adhesive connection, a welded connection, or by a force-fit connection. The latter can be achieved when the inner diameter of the connection opening 8 is smaller than the outer diameter of the pipe end 9. If necessary, the preferably cylindrical connection opening 8 can also be conical in order to simplify a force-fit process. If necessary, there can also be a threaded connection, where self-tapping threads can be provided, e.g., in the walls of the connection opening 8.

There is a gap between the section of the extension part 11 in the insertion space 6 and the inner cylinder walls of the insertion space 6, so that there is an annular, groove-like receptacle space 15 which is open against the insertion direction of the connecting element 3. The insertion direction is marked by an arrow 16 in FIGS. 3 and 6.

The receptacle space 15 is defined by an axial sealing surface 17 and a radial sealing surface 18. The axial sealing surface 17 is preferably a flat annular surface. If necessary, however, this sealing surface 17 can also be conical or slightly arched. The sealing surface 18 is preferably a cylindrical surface; however, if necessary, the surface can also be slightly conical or arched. When acceptable to production techniques, the diameter of the sealing surface 18 can be slightly expanded in the insertion direction (in FIG. 3, from left to right).

The sealing surfaces 17, 18 are used as contact and setting surfaces for an annular sealing element 19, e.g., an O-ring or another sealing element made from an elastomer with a rectangular cord cross section or with sealing lips. The outer diameter of the sealing element 19 is preferably somewhat greater than the inner diameter of the sealing surface 18 so that the sealing element 19 is held by friction-fit in the receptacle space 15. The cord diameter of the sealing element 19 (cross section) is greater than the depth of the receptacle space 15 measured in the insertion direction 16. Thus, the projection of the extension part 11 past the sealing surface 17 is correspondingly smaller than the cross-sectional diameter of the sealing element 19.

At its front side facing the insertion space 6, the extension part 11 features an annular support surface 21 that is preferably configured as a flat surface and that is arranged coaxial to the sealing element 19. The support surface 21 preferably lies within the sealing element. The distance between the support surface 21 and the sealing surface 18 determines the height of the receptacle space 15 in the insertion direction 16.

The connecting element 3 is essentially configured as a pipe piece with an annular flange 22 at its end. This flange features an annular surface on its side facing the receptacle space 15, with an outer part that is used as an annular sealing surface 23 and with an inner part that is used as an annular support surface 24. Both the sealing surface 23 and also the support surface 24 can be configured as planar or also conical or arched. Planar surfaces are preferred due to their simple manufacture and the clear sealing and support relations. Thus, the support surface contacts the support surface 21 in a planar (gap-free) manner.

For connecting a pipe or another line to the connecting element 3, a corresponding line end 25 can be pushed into the tubular projection of the connecting element 3. For limiting the insertion depth, as indicated by FIGS. 3 and 6, there can be annular inner ribbing 26 on the inner circumference surface of the connecting element 3. The inner diameter of the connecting element 3 can be defined to correspond to both sides of the ribbing 26. If necessary, however, a somewhat larger diameter can be chosen on the side facing the connecting element 2 in order to make it easier to push on a pipe end 9 projecting through the connecting element 2 (FIG. 6). For connecting the line end 25 and the connecting element 3, adhesive connections, threaded connections, force-fit connections, welding connections, and other connection methods or means can be used. Adhesive and welding connections or other self-locking connections are preferred due to their reliability.

The outer diameter of the annular flange 22 is preferably only slightly smaller than the inner diameter of the insertion space 6. On its side facing the receptacle space 15, the annular flange 22 features a flat surface (planar surface) 27 that is used as a pressure or clamping surface in order to clamp the connecting element 3 in the direction of the arrow 16 against the connecting element 2.

A wedge element 28 shown separately in FIG. 7 is used for this purpose and has two similarly oriented, parallel wedges 31, 32 that are connected together by a crosspiece 33. Thus, the wedges 31, 32 form the legs of a U-shaped element. The distance between the wedges 31, 32 corresponds approximately to the outer diameter of the connecting element 3, wherein the corresponding sides of the wedges 31, 32 are oriented parallel to each other.

The wedge 31 features a wedge surface 34 that is designed as a flat, planar surface and that lies in a common plane with a planar wedge surface 35 of the wedge 32. When the wedge element 28 is engaged with the connecting element 2, as indicated in FIG. 4, the planar surfaces 34, 35 are oriented essentially in the axial direction, i.e., their surface normal lines approximately match the axial direction of the connected lines. On the opposing sides, the wedges 31, 32 feature similar planar surfaces 36, 37 that lie in a common plane. FIG. 6 illustrates the planar surface 36 of the wedge 31. The planar surface 37 is found at a corresponding position on wedge 32. With the planar surfaces 36, 37, the wedge surfaces 34, 35 form an acute angle that is preferably approximately 10° or even smaller. This acute angle acts as a wedge angle, wherein a wedge angle that is clearly under 10° is favorable for the self-locking of the wedges 31, 32.

As shown particularly in FIG. 8, the wedges 31, 32 are associated with recesses 38, 39 that are slot-shaped and that penetrate the walls of the connecting element 2. The depth of the recesses 38, 39 is sufficient for the insertion space 6 to be accessible through the recesses 38, 39. Between the recesses 38, 39, there remains a crosspiece 43 limited by floor surfaces 41, 42, whose width approximately corresponds to the distance between the wedges 31, 32. This distance is approximately as large as the outer diameter of the connecting element 3.

As indicated in FIGS. 6 and 8, the recesses 38, 39 are limited at their side contacting the front wall 7 by inclined surfaces 44, 45 that feature the same orientation as the wedge surfaces 34, 35. Opposite the inclined surfaces 44, 45 are limiting surfaces 46, 47 that can be oriented parallel or with an acute angle to the inclined surfaces 44, 45. The distance between the limiting surfaces 46, 47 and the inclined surfaces 44, 45 is sufficient to enable the wedges 31, 32 to be pushed into the recesses 38, 39 until the crosspiece 33 contacts the crosspiece 43. With the inclined surfaces 44, 45 formed on the connecting element 2, the wedges 31, 32 form a wedge-clamping device that converts an insertion movement of the wedges 31, 32 linearly and proportionally into a clamping movement. Dimensional tolerances of the connecting elements 2, 3 can be compensated for by different insertion depths of the wedge.

In an advantageous embodiment, the width of the wedge surfaces 34, 35, and thus the width of the wedge 31, 32, approximately corresponds to the depth of the recesses 38, 39, i.e., the outer sides of wedges 31, 32 are sealed flush with the connecting element 2, as indicated particularly in FIGS. 2 and 5.

At their free ends, the wedges 31, 32 can be provided with insertion aids and insertion bevels, as indicated particularly in FIG. 7. In addition, the wedge surfaces 34, 35 and the inclined surfaces 44, 45 can be arched, e.g., in order to give the wedges 31, 32 improved lateral guidance.

For securing the wedge element 28 to the connecting element 2, the wedge element 28 can be provided with a locking device 51. This device includes, e.g., toothing 52 on the outer side of the connecting element 2 adjacent to the recesses 38, 39. This toothing features at least one individual tooth, and its individual teeth 53 are oriented in the axial direction. As indicated by FIG. 8, the teeth can be configured with a sawtooth shape that features contact surfaces 55 oriented perpendicular to the arrow 54 in FIG. 8 and deflection surfaces 56 oriented at an angle to the insertion direction (arrow 54).

The toothing 52 is associated with locking clamps 57, 58 that are each connected at an end 61, 62 to the wedge element 28, e.g., to its crosspiece 33. The locking clamps 57, 58 feature a certain spring elasticity, particularly when the wedge element 28 is made from plastic, which is preferred. At its inner side, the locking clamps 57, 58 carry at least one tooth or toothing that is complementary to the toothing 52 and that defines several locking positions of the wedge element 28 to the connecting element 2 according to the fineness of the toothing. This toothing 59 (FIG. 7) can extend over the entire inner side of the locking clamp 57, 58 or it can be interrupted, as shown in FIG. 7. According to FIG. 7, the locking clamp 57 features at its free end a single tooth 64 that is used to support the wedge element 28 on the connecting element 2 in the plugged and disconnected position. There is a gap between the tooth 64 and the remaining toothing 59.

The connecting device 1 described thus far operates as follows:

For forming a fluid connection between two lines by means of the connecting device 1, the wedge element 28 on the connecting element 2 is initially brought into the position shown in FIG. 4, in which the free ends of the locking clamp 57, 58 sit on the toothing 52 and the free ends of the wedges 31, 32 are essentially released from the insertion space 6, as shown particularly in FIG. 5.

As shown by FIG. 6, the connecting elements 2, 3 are already connected to corresponding line ends 9, 25. The connecting element 3 is inserted into the insertion space 6, wherein, if necessary, it is pushed against an end 9a of the pipe end that projects through the insertion space 6. However, in each case, the depth of insertion of the connecting element 3 into the insertion space 6 is sufficient to enable the planar surface 27 to grip behind the limiting surface 46, 47 or reach approximately the same depth. In this state, the wedge element 28 moves on the connecting element 2 in the insertion direction marked by arrow 54 in FIG. 6 such that the crosspiece 33 approaches the crosspiece 43. Thus, the ends of the wedges 31, 32 enter into the insertion space 6, as particularly shown in FIG. 2. In this way, the wedge surfaces 34, 35 contact the inclined surfaces 44, 45 (FIG. 1). The wedges 31, 32 press against the planar surface 27 of the annular flange 22 with their planar surfaces 36, 37. This is initially pressed against the O-ring 19, whereby the O-ring 19 is deformed. Finally, the support surface 24 of the annular flange 22 rigidly contacts the support surface 21, whereby the deformation of the sealing element 19 is limited. The wedge element 28 is now pressed tight to the connecting element 2 until no further movement is possible with normal activation forces. The support surfaces 21, 24 are now clamped rigidly against each other, resulting in a mechanically rigid setting. The toothing 59 of locking clamps 57, 58 engages the toothing 52 and secures the wedge element in this clamped position. The sealing element 19 seals the connection so that it is fluid-tight.

The connection is formed in a simple way and can be assembled and manufactured with a reliable process in spite of manufacturing tolerances that correspond to the diameter of the or connecting elements 2, 3 as well as to the length of these connecting elements. In addition, good impermeability is guaranteed.

The impermeability can be improved even more with the embodiment according to FIGS. 9 and 10. The essential difference with the previously described embodiment is that the support surface 21 is not arranged inside the sealing element 19 like for the previously described embodiment, but rather is arranged outside of this sealing element. For this purpose, the connecting element 3 features an inner shoulder 65 surrounding the receptacle space 15 in the insertion space 6. This shoulder sets an annular surface used as support surface 21. This annular surface is a planar surface, e.g., and directly contacts the radial sealing surface 18. The distance between the annular surface and the sealing surface 17 measured in the insertion direction 16, in turn, is somewhat smaller than the cord diameter of the sealing element 19, so that the sealing element 19 is held in compression when the annular flange 22 contacts the annular surface (support surface 21). Correspondingly, on the annular flange, the support surface 24 is provided in an outer region in the radial direction, while the sealing surface 23 is arranged in an inner region in the radial direction and features a radius that approximately corresponds to the radius of the sealing element 19. The wedge-clamping device with clamping wedges 31, 32 and the inclined surfaces 44, 45 as the counter-clamping element is used for clamping the connecting elements 2, 3 together.

This embodiment of the connecting device 1 is suitable, particularly for coupling fluid channels guiding a fluid that is inclined so that the fluid can diffuse through the sealing element 19. At the side facing the fluid channel 4, 5, the sealing element (O-ring) 19 is exposed to the fluid on a surface that approximately corresponds to the length of the receptacle space multiplied by the inner circumference of the sealing element 19. Through this surface, the O-ring 19 can store fluid as far as the fluid can penetrate into the elastomer material. However, the fluid can only be given off to the outside through the gap enclosed between the support surfaces 21, 24. The width of this gap is practically zero. At this gap, the sealing element 19 is under pressure. Thus, the surface, by means of which the O-ring can give off fluid, is extremely small, practically zero. Due to the high (approaching infinity) surface ratio between the inner circumferential surface of the O-ring and the surface bridging the gap, the diffusion loss can be minimized and made practically zero.

Another advantage of this embodiment is the large radius of the support surface, which can guarantee a non-inclined setting of the connecting elements 2, 3 relative to each other due to the clamping effect of the wedge.

Another feature of the embodiment illustrated in FIGS. 9 and 10 is that the connecting element 3 is configured in two pieces. It is divided into an outer shoulder part 3a and an insert part 3b. The shoulder part 3a features on its front wall 7 a seat opening 68, into which the insert part 3b is inserted. The insert part 3b is essentially formed by a disk with a central hole. The disk features corresponding tubular extensions at its outer edge and around its inner hole. The extensions extend away from the disk in different directions.

The two-piece structure of the connecting element 3 enables a more simple production.

Another embodiment variant of the connecting device 1 is illustrated in FIGS. 11 and 12. Compared with the previously described embodiment (FIGS. 9 and 10), the special feature of this embodiment is the setting of the O-ring 19. It sits in a receptacle space 15 that is configured on one half as an annular groove in the annular flange 22 and, on the other half, as an annular groove in the front wall 7 or a corresponding annular flange 69 provided at the insert part 3a. The annular groove at both the annular flange 22 and the annular flange 69 is surrounded to the inside and outside in the radial direction by parts of the support surface 21 and 24, respectively. This means that the support surface 21 of the connecting element 2 is divided into an outer support surface 21a and an inner support surface 21b. Similarly, the support surface 24 of the connecting element 3 is divided into an outer support surface 24a and an inner support surface 24b. Preferably, the support surfaces 21a,b and 24a,b are configured or axially positioned such that the axial support is achieved predominately at the outer surface regions 21a, 24a. This benefits the impermeability in the same way as explained in connection with FIGS. 9 and 10. This is achieved because the surface regions 21b and/or 24b are each somewhat behind the surface regions 21a, 24a in the axial direction. A distance of a few hundreds or tens of millimeters is sufficient.

If necessary, several annular grooves can be provided in the annular flanges 22, 69 as the setting for several concentric sealing elements. This embodiment has the advantage of good impermeability. In addition, for this structure, the diameter of the connecting element 3 is somewhat larger, i.e., the insertion space 6 features a somewhat larger diameter. Thus, as shown by FIG. 11, the recesses 38, 39 can be designed less like grooves, rather like through-plug openings. This has the advantage that the wedges 31, 32 are also guided into the recesses 38, 39 at the side (in the radial direction). Thus, the mechanical stress of the crosspiece 33 is essentially less. In this way, the reliability of the connecting device 1, particularly relative to mechanical stresses, can be increased. In addition, locking clamps 57, 58 can be provided for stationary securing of the wedge element 28.

Another embodiment of the connecting device 1 is shown in FIG. 13. Like the previously described embodiments, this embodiment includes two connecting elements 2, 3 to be joined in the axial direction. The connecting element 2 essentially corresponds to the connecting element 2 illustrated in FIGS. 9 and 10 with the difference that it is designed as one piece. At its front wall 7 there is a tubular extension that points outwards and that is connected fluid-tight to the pipe or hose 9 to be connected. At its inner side, the front wall 7 features an annular planar surface that is used as a support and sealing surface. In the present embodiment, there is an inner section of this surface in the radial direction that connects to the passage opening 8 as a sealing surface 17. An outer part of this planar surface is used as support surface 21. An annular shoulder or the like as a contact surface for the annular flange 22 of the connecting element 3 is not provided in the insertion space 6.

Instead, the sealing element 19 has a special configuration. It features a sealing section 19a, that is formed, e.g., by an elastomer, another elastic sealing means, or, if necessary, also by a plastic sealing means in the form of a closed ring. In its outer section 19b, the sealing element 19 is used as a support element. For example, the section 19b is designed as a support ring made from a rigid material, e.g., metal or an industrial plastic. This support ring can be designed as a closed, or also as a single or multiple slit ring. It is possible to connect the support ring rigidly to the sealing section 19a, e.g., by means of adhesive or by vulcanizing the section 19a made from elastomer material. Alternatively, the section 19b can be a support ring that is not connected to the sealing section 19a, but is only connected by a force fit in certain regions or otherwise, e.g., connected by a form fit. The thickness of the support element 19b measured in the axial direction is smaller in all cases than the thickness (expansion) measured in the axial direction of the sealing section 19a used as a sealing ring.

A connecting device 1 is provided particularly as a quick-connect device for connecting fluid channels on motor vehicles. The connecting device features two axial connecting elements 2, 3 that are to be clamped and that are sealed with a sealing element 19 to be deformed in the axial direction. The deformation of the sealing element 19 is limited by mechanical stop means (support surfaces 21, 24). A wedge-clamping direction is used for clamping the connecting elements 2, 3 against each other.

1. Connecting device (1), particularly quick-connect device for connecting fluid lines, with a first connecting element (2) that includes a line channel (4) and that features an annular receptacle space (15) with an annular, axial sealing surface (17) and a radial sealing surface (18), wherein the connecting element (2) features an annular first support surface (21) and an inclined surface (44), with an annular sealing element (19) that is arranged in the receptacle space (15) and that contacts the sealing surfaces (17, 18), with a second connecting element (3) that includes a line channel (5) and that features an annular, axial sealing surface (23) for the sealing element (19) and an annular second support surface (24) that contacts the first support surface (21) in the assembled state of the connecting device (1), and with a wedge-clamping device (28, 2, 2a) with a wedge element (28) that features at least one wedge (31) with a wedge surface (34) for axial clamping of the connecting elements (2, 3) against each other, wherein the wedge surface (34) of the wedge (31) and the inclined surface (44) of the first connecting element (2) contact each other in the assembled state.

2. Connecting device according to claim 1, characterized in that the annular sealing element (19) is an O-ring.

3. Connecting device according to claim 1, characterized in that the radial sealing surface (23) of the first connecting element (2) contacts the sealing surface (18) of the second connecting element (3) without a gap when the connecting elements (2, 3) are clamped against each other.

4. Connecting device according to claim 1, characterized in that the support surfaces (21, 24) are planar surfaces.

5. Connecting device according to claim 1, characterized in that the wedge-clamping device (28, 2, 2a) includes a holder body (2, 2a) that features at least one clamp opening (38, 39) arranged perpendicular to its longitudinal direction (16), where a clamping wedge (31, 32) can be inserted into this opening.

6. Connecting device according to claim 5, characterized in that the holder body (2, 2a) features two parallel clamp openings (38, 39) and the clamp openings (38, 39) enclose the fluid channel (4, 5) between each other.

7. Connecting device according to claim 5, characterized in that the clamp openings (38, 39) are formed by grooves.

8. Connecting device according to claim 7, characterized in that the grooves are wedge grooves.

9. Connecting device according to claim 1, characterized in that the second connecting element (3) features an annular flange (22) with a clamping surface (27) for the clamping wedge (31, 32).

10. Connecting device according to claim 1, characterized in that the clamping wedge (31, 32) is connected to a locking device (57, 58).

11. Connecting device according to claim 1, characterized in that the clamping wedge (31, 32) is made from plastic.

12. Connecting device according to claim 6, characterized in that each clamp opening (38, 39) is associated with a clamping wedge (31, 32) and the two clamping wedges (31, 32) are connected by a crosspiece (33).

13. Connecting device according to claim 1, characterized in that a support device (21) is arranged at the connecting element (2).

14. Connecting device according to claim 1, characterized in that between the connecting elements (2, 3) there is a support device (19b) that is unconnected to the connecting elements (2, 3).
